(19) United States
(12) Patent Application Publication
(10) Pub. No.: US 2009/0149230 A1
(43) Pub. Date: Jun. 11, 2009

(54) SLIDE MECHANISM FOR SLIDE-TYPE PORTABLE TERMINAL DEVICES

(75) Inventor: XIANG-DONG RUAN, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/182,109

(22) Filed: Jul. 29, 2008

(30) Foreign Application Priority Data
Dec. 10, 2007 (CN) 200710202962.5

(51) Int. Cl. H04M 1/00

(52) U.S. Cl. 455/575.4

(57) ABSTRACT

An exemplary slide mechanism includes a fixing unit, a connecting unit, and a slidable unit slidably coupled to the fixing unit. The fixing unit includes a rear cover and a pair of slide rails securely disposed on the rear cover. Each of the slide rails has a turn. The slide rails are spaced from each other and the turns are opposite to each other. The connecting unit is disposed between the fixing unit and the slidable unit. The connecting unit includes two slidable members for engaging with the slide rails. The slidable members are slidable relative to each other. The slidable members and the slide rails are magnetic, and polarities of the end of each the slidable member and an inner surface of a corresponding slide rail engaging with the slidable member are the same.

### BACKGROUND OF THE INVENTION

1. Field of the Invention

The present invention relates to slide mechanisms, and particularly, to a slide mechanism for a slide-type portable terminal device.

2. Discussion of the Related Art

Slide-type portable terminal devices, such as slide-type mobile phones, are very popular. The slide-type portable terminal usually has two housings, where one housing slides over the other housing to open or close the portable terminal device.

Referring to FIG. 5, a typical slide mechanism includes a base body 220 and a connecting module 320. A pair of guide rails 240 is symmetrically formed on the base body 220. Each guide rail 240 has a first portion 241 and a second portion 243 connected to the first portion 241 forming a joint (not labeled). The first portion 241 and the second portion 243 extend toward contrary directions. A distance between the guide rails 240 progressively increases as the distance from the joint of the first and second portions 241, 243 increases. Two blocks 247, 249 are correspondingly formed at opposite ends of each guide rail 240.

The connecting module 320 includes an outer sleeve 331, an inner sleeve 333, two wheels 340, and a spring 360. The outer sleeve 331 defines a cavity for receiving the inner sleeve 333 and an end of the spring 360. The inner sleeve 333 defines a cavity for receiving another end of the spring 360. The inner sleeve 333 is slidably received in the outer sleeve 331. Two ends of the spring 360 resist the outer sleeve 331 and the inner sleeve 333 correspondingly. The wheels 340 are rotatably fixed to the ends of the outer sleeve 331 and the inner sleeve 333 and configured to slidably engage with the guide rails 240.

The slide mechanism has two stable states. In a first state, the outer sleeve 331 and the inner sleeve 333 are adjacent to the blocks 247, and the spring 360 is slightly compressed. When an external force is applied to push the outer sleeve 331 and the inner sleeve 333 to slide along the guide rails 240, the inner sleeve 333 slides into the outer sleeve 331 further and compresses the spring 360. The spring 360 reaches its greatest compressive state when the outer sleeve 331 and the inner sleeve 333 is at the joint of the first portion 241 and the second portion 243. When the outer sleeve 331 and the inner sleeve 333 pass the joints, the external force can be removed, and the outer sleeve 331 and the inner sleeve 333 are forced to slide along the guide rails 240 by an elastic force of the spring 360 until the outer sleeve 331 and the inner sleeve 333 abut the blocks 249. The slide mechanism is in the second state.

In this configuration, a relatively large friction force is generated between the wheels 340 and the guide rails 240. The friction force may make it difficult for the outer sleeve 331 and the inner sleeve 333 to slide along the guide rails 240, and components may be damaged by abrasion.

Therefore, a slide mechanism which overcomes the above-described shortcomings is desired.

### SUMMARY

An exemplary slide mechanism includes a fixing unit, a connecting unit, and a slidable unit. The fixing unit includes a rear cover and a pair of slide rails securely disposed on the rear cover. Each of the slide rails has a turn. The slide rails are spaced from each other and the turn of each slide rail is opposite to the turn of the other slide rail. The slidable unit is slidably coupled on the fixing unit. The connecting unit is disposed between the fixing unit and the slidable unit. The connecting unit is configured to be connected to the slidable unit and engage with the slide rails, so as to make the slidable unit capable of automatically sliding relative to the fixing unit once the slidable unit passing the turns. The connecting unit includes two slidable members for engaging with the slide rails. The slidable members are slidable relative to each other. The slidable members and the slide rails are magnetic, and polarities of the end of each the slidable member and an inner surface of a corresponding slide rail engaging with the slidable member are the same.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the slide mechanism. Moreover, in the drawings, like reference numerals designate corresponding parts throughout the several views.

FIG. 1 is an exploded, isometric view of an embodiment of a slide mechanism.

FIG. 2 is an assembled, isometric view of the slide mechanism of FIG. 1, showing a closed state of the slide mechanism.

FIG. 3 is an assembled, isometric view of the slide mechanism of FIG. 1, showing a middle state of the slide mechanism.

FIG. 4 is an assembled, isometric view of the slide mechanism of FIG. 1, showing an open state of the slide mechanism.

FIG. 5 is an exploded, isometric view of a typical slide mechanism.

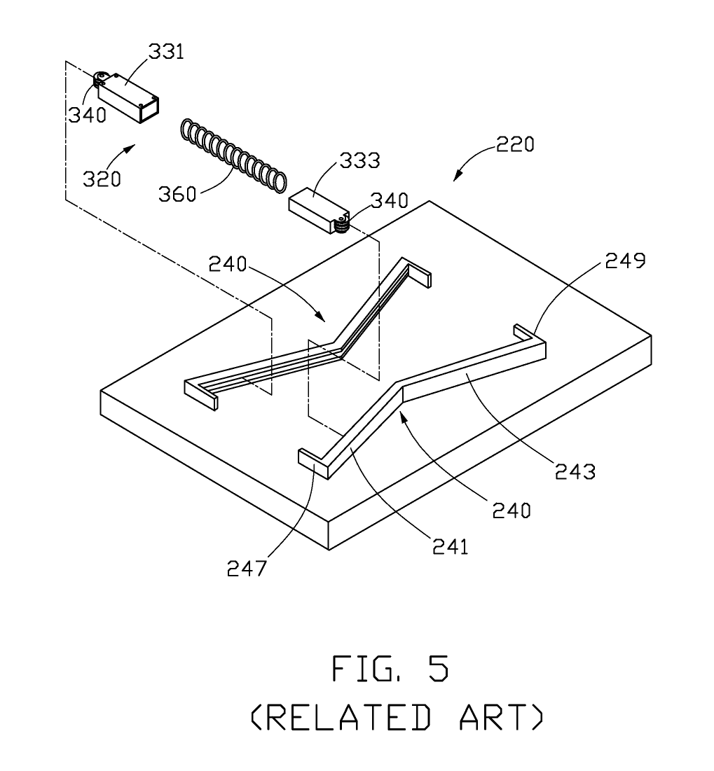

### DETAILED DESCRIPTION OF THE EMBODIMENTS

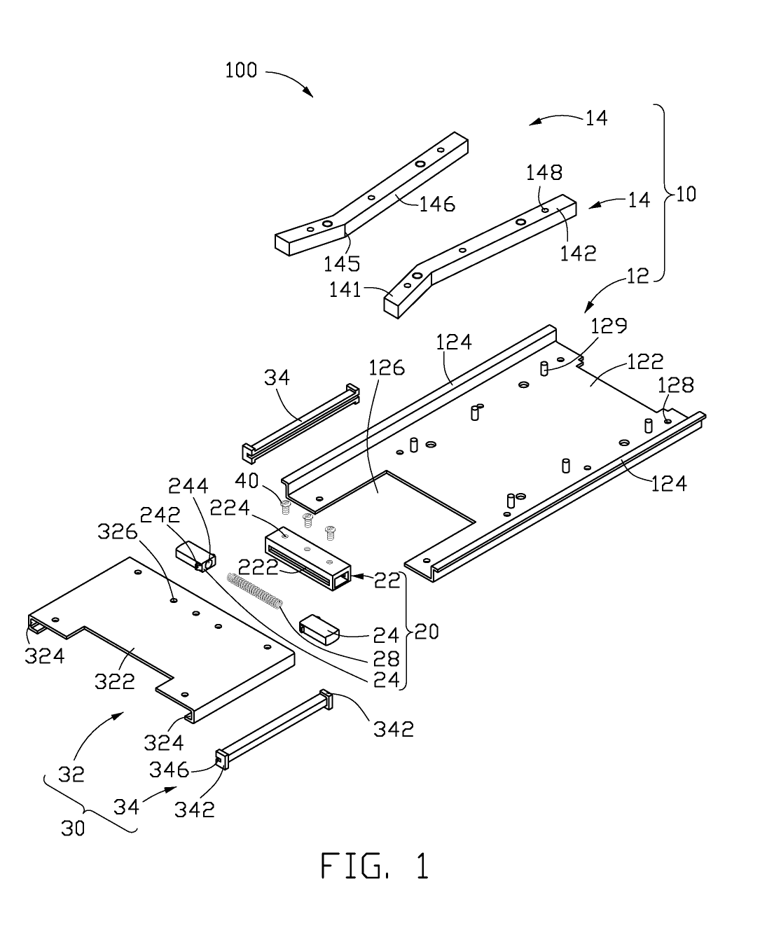

Referring to the drawings in detail, FIG. 1 shows a slide mechanism 100 including a fixing unit 10, a connecting unit 20, and a slidable unit 30. In the illustrated embodiment, the slide mechanism 100 is applied to a slide-type mobile phone with a main body and a slide cover slidably connected to the main body.

The fixing unit 10 includes a rear cover 12 and two slide rails 14. The rear cover 12 is substantially a flat sheet having a main plate 122 and two side strips 124 formed at opposite sides of the main plate 122. The side strips 124 extend along the corresponding opposite sides of the main plate 122. The main plate 122 defines a cutout 126 at a distal end and a plurality of circular holes 128 for connecting the rear cover 12 to the main body of the mobile phone. The rear cover 12 further forms a plurality of pins 129. The slide rails 14 are symmetrically mounted on the rear cover 12. The slide rails 14 are magnetic (e.g., made of magnetic materials or adhered with magnetic elements). For exemplary purposes, only one of the slide rails 14 will be detailed. The slide rail 14 is configured with a first portion 141 and a second portion 142. The first and second portions 141, 142 are connected to each other at an angle around a middle portion of the slide rail 14 forming a corner (not labeled), such that the outer ends of the first and second portions 141, 142 extend toward contrary directions. In another embodiment, the slide rails 14 may be curve-shaped. When the slide rails 14 are mounted on the rear cover 12, a distance between the slide rails 14 is smallest at a neck (not labeled) between the corners of the first and second portions 141, 142, thus forming a turn 145 on each of the slide rails 14. It may be appreciated that each of the slide rails 14 may have two or more turns 145. Furthermore, one of the slide rails 14 may not has any turn 145, so long as a distance between the slide rails 14 increases from at least one position towards two ends. The distance between the slide rails 14 gradually increases from the turns 145. Each slide rail 14 has an inner surface 146 facing the inner surface 146 of the other slide rail 14. The slide rails 14 define a plurality of holes 148 for engaging with the pins 129 to fix the slide rails 14 on the rear cover 12. In one embodiment, the slide rails 14 may be integrally formed with the rear cover 12.

The connecting unit 20 includes a housing 22, two slidable members 24, and an elastic member 28. The housing 22 is a hollowed frame for receiving the elastic member 28 and at least part of the slidable members 24. The housing 22 defines two slide slots 222 in two corresponding opposite sides, and a plurality of threaded holes 224 in a top side. The slidable members 24 are magnetic. Each slidable member 24 forms two protrusions 242 which are at two opposite sides correspondingly. Each protrusion 242 has an inclined surface for facilitating the slidable member 24 to slide into the housing 22. The slidable member 24 defines a positioning hole 244 in an end. The elastic member 28 is a spring.

The slidable unit 30 includes a front cover 32 and two guide rails 34. The front cover 32 is substantially a flat sheet having a main plate 322 and two flanges 324 formed at opposite sides of the main plate 322. The main plate 322 defines a plurality of connecting holes 326 corresponding to the threaded holes 224. The guide rails 34 are substantially elongated bars. A pair of projections 342 is formed at opposite ends of each guide rail 34. Each guide rail 34 further defines a guiding groove 346. The guiding grooves 346 are configured for engaging with the corresponding side strips, such that the guide rails 34 can slidably engage with the rear cover 12. The guide rails 34 are securely engaged to the corresponding flanges 324.

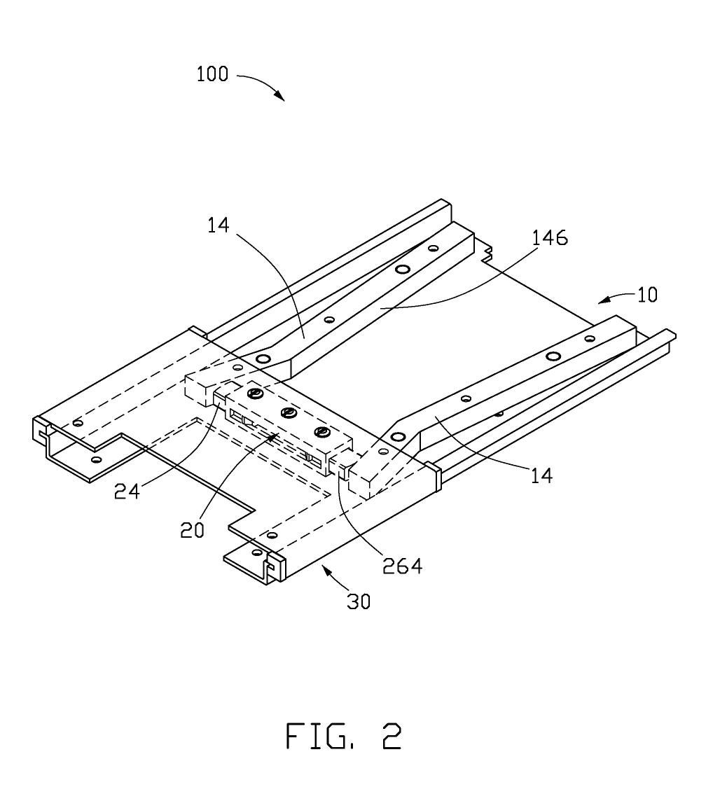

Referring to FIG. 2, the fixing unit 10 is formed when the pins 129 of the rear cover 12 are securely inserted into the holes 148 of the slide rails 14. One end of the elastic member 28 is inserted into the positioning hole 244 of one of the slidable members 24. The slidable member 24 with the elastic member 28 and the other slidable member 24 are inserted into the housing 22 from opposite ends of the housing 22 with the protrusions 242 engaged in the corresponding slide slots 222 to form the connecting unit 20. The slidable members 24 are slidable in the housing 22 but the ends of the elastic member 28 resist the slidable members 24. The connecting unit 20 is fixably attached to the front cover 32 by making a plurality of bolts 40 engaging the threaded holes 224 and the connecting holes 326. In alternative embodiment, one of the slidable members 24 may fixed to the housing 22 and another slidable member 24 slidable relative to the housing 22, so long as the slidable members 24 are slidable relative to each other. In the illustrated embodiment, the guide rails 34 are fixed to the front cover 32. The front cover 32 is coupled to the rear cover 12 such that the side strips 124 slidably engage in the corresponding guiding grooves 346. In another embodiment, the slide rails 14 may be omitted. Accordingly, the rear cover 12 defines two slots and each slot has an inner surface for engaging with the slidable members 24.

The connecting unit 20 is fixably attached between the rear cover 12 and the front cover 32. The polarities at the end of each slidable member 24 and the inner surface 146 resisting the slidable member 24 are the same. In this embodiment, even if the slidable members 24 are quite close to each other, the slidable members 24 will not be away from the slide rails 14 because magnetic force generated between the slidable members 24 is a repulsive magnetic force.

FIG. 2 is a slide mechanism 100 in a closed position. The slidable unit 30 is positioned at a first end of the fixing unit 10, the connecting unit 20 is positioned at a first end of the slide rails 14, and the elastic member 28 is substantially released. A repulsive magnetic force is generated between the slidable members 24 and the inner surfaces 146 of the slide rails 14. To change from the closed position to an opened position, the slidable unit 30 is moved from the first end to the second end of the fixing unit 10 by an applied external force. The connecting unit 20 slides to the second end of the fixing unit 10 together with the slidable unit 30. The slide rails 14 force the slidable members 24 to slide along the slide slots 222 of the housing 22 and towards each other, thereby compressing the elastic member 28.

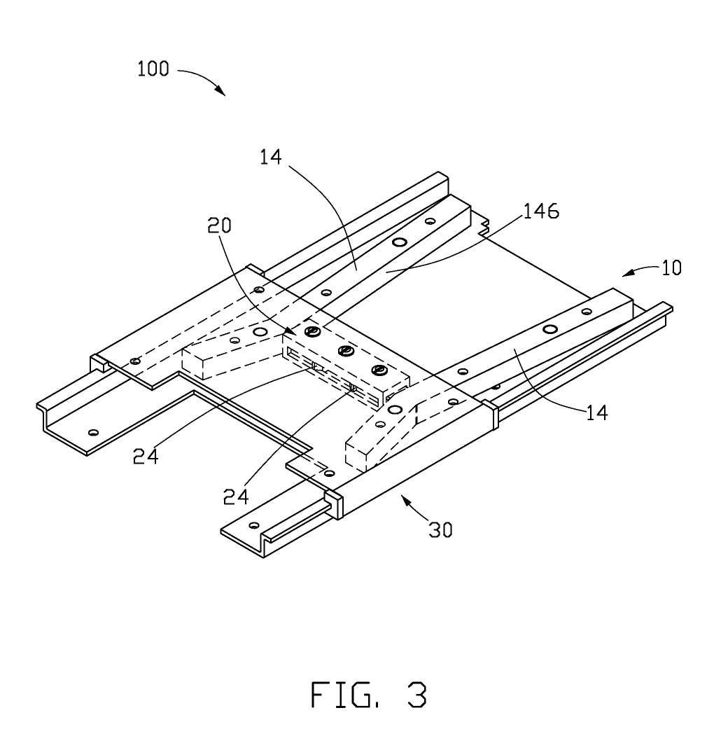

Referring to FIG. 3, when the slidable unit 30 slides to the turns 145, the elastic member 28 is at its most compressed state.

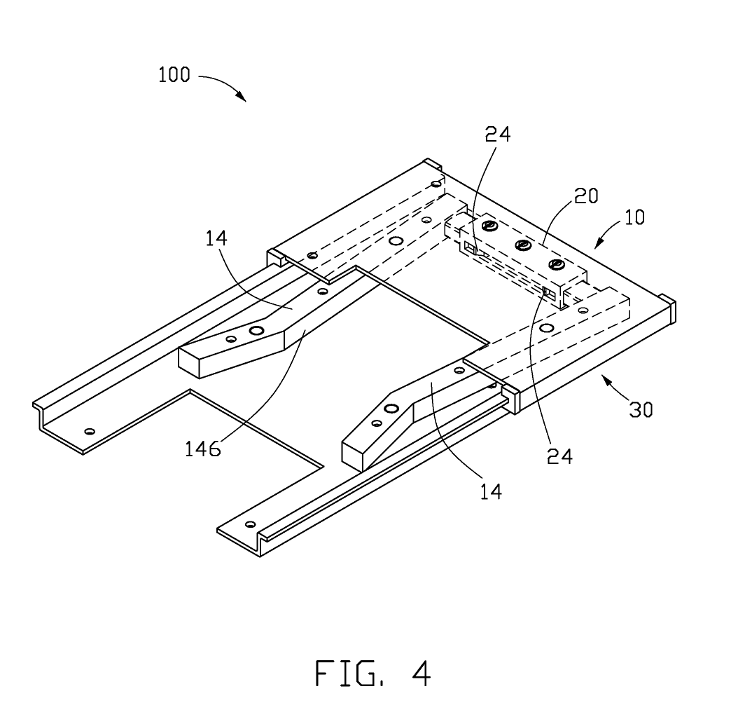

Referring to FIG. 4, when the slidable unit 30 slides past the turns 145 of the slide rails 14, the applied external force can be released (discontinued) because the elastic force of the elastic member 28 pushes the slidable unit 30 to move towards the second end of the fixing unit 10. The slide mechanism 100 is now fully opened. To change from the opened position to the closed position, another external force is applied to move the slidable unit 30 from the second end towards the first end of the fixing unit 10. The process of closing the slidable unit 30 and the above-described opening process are substantially in the same manner.

When opening or closing the slidable unit 30 along the fixing unit 10, a pressure between the slidable members 24 and the slide rails 14 is quite small or nonexistent, because of a repulsive magnetic force. Therefore, when the slidable unit 30 is sliding, a friction force between the slidable members 24 and the slide rails 14 is very small or negligible. Thus, the slidable unit 30 can slide smoothly. Opening or closing the slide mechanism 100 becomes very convenient for users and the components of the slide mechanism 100 are protected against abrasion.

In one embodiment, the elastic element 28 forcing the slidable unit 30 to slide may be replaced by a magnetic force. Instead, ends of the slidable members 24 facing each other have the same polarities, generating a repulsive magnetic force between the slidable members 24, and forcing the slidable unit 30 to automatically slide once the slidable unit 30 passing the turns 145 of the slide rails 14.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A slide mechanism, comprising:
a fixing unit comprising a rear cover and a pair of slide rails securely positioned on the rear cover, wherein each of the slide rails comprises at least one turn; the slide rails are spaced from each other; the at least one turn of each slide rail is opposite to the at least one turn of the other slide rail;
a slidable unit slidably coupled on the fixing unit; and
a connecting unit positioned between the fixing unit and the slidable unit, wherein the connecting unit is connected to the slidable unit and engaging with the slide rails, so as to make the slidable unit being capable of automatically sliding relative to the fixing unit once the slidable unit passes two opposite turns; the connecting unit comprises two slidable members for engaging with the slide rails; the slidable members being slidable relative to each other; the slidable members and the slide rails are magnetic; polarities of the end of each of the slidable member and an inner surface of a corresponding slide rail engage with the slidable member being the same.

2. The slide mechanism of claim 1, wherein the connecting unit further comprises an elastic member positioned between the slidable members such that the slidable unit is capable of automatically sliding under a force of the elastic member once the slidable unit passes the turns.

3. The slide mechanism of claim 2, wherein ends of slidable members facing each other have the same polarities.

4. The slide mechanism of claim 1, wherein ends of slidable members facing each other have the same polarities.

5. The slide mechanism of claim 1, wherein the at least one turn of each slide rail is one turn.

6. The slide mechanism of claim 2, wherein the connecting unit further comprises a housing fixed to the slidable unit; the housing is a hollowed frame for receiving the elastic member and at least part of the slidable members; the housing defines two slide slots at two opposite sides; each slidable member forms two protrusions at two opposite sides for slidably engaging with the corresponding slide slots of the housing.

7. The slide mechanism of claim 6, wherein the slidable unit comprises a front cover and two guide rails fixed on the front cover; each of the guide rails defines a guiding groove; the rear cover of the fixing unit is substantially a flat sheet having a main plate and two side strips formed at opposite sides of the main plate; the guiding grooves are configured for engaging with the corresponding side strips of the rear cover.

8. The slide mechanism of claim 7, wherein the front cover is substantially a flat sheet comprising a main plate and two flanges formed at opposite sides of the main plate; the guide rails are received in the flanges of the front cover, and a pair of projections are formed at opposite ends of each of the guide rails.

9. The slide mechanism of claim 2, wherein the elastic member is a compressed spring.

10. The slide mechanism of claim 2, wherein each of the slidable members defines a positioning hole at one end; two ends of the elastic member are received in the positioning holes of the slidable members and resist the slidable members.

11. A slide mechanism comprising:
a fixing unit having a pair of engaging surfaces;
a slidable unit slidably coupled on the fixing unit; and
a connecting unit disposed between the fixing unit and the slidable unit, wherein the connecting unit comprises two slidable members for engaging with the engaging surfaces; the slidable members are slidable relative to each other; the slidable members and the engaging surfaces are magnetic; polarities of the end of each the slidable member and the corresponding engaging surface are the same.

12. The slide mechanism of claim 11, wherein ends of slidable members facing each other have the same polarities.

13. The slide mechanism of claim 11, wherein the connecting unit further comprises an elastic member positioned between the slidable members; at least one of the engaging surfaces have at least one turn; the slidable unit is capable of automatically sliding under force of the elastic member once the slidable unit passing each of the at least one turn.

14. The slide mechanism of claim 13, wherein ends of slidable members facing each other have the same polarities.

15. The slide mechanism of claim 13, wherein the fixing unit comprises a rear cover and a pair of slide rails securely positioned on the rear cover; each of the slide rails has a turn; the slide rails are spaced from each other and the turn of each slide rail is opposite to the turn of the other slide rail; and the engaging surfaces are defined on the slide rails.

16. The slide mechanism of claim 13, wherein the connecting unit further comprises a housing fixed to the slidable unit; the housing is a hollowed frame for receiving the elastic member and at least part of the slidable members; the housing defines two slide slots at two opposite sides; each slidable member forms two protrusions at two opposite sides for slidably engaging with the slide slots of the housing.

17. The slide mechanism of claim 13, wherein the elastic member is a compressed spring.

18. The slide mechanism of claim 13, wherein each of the slidable members defines a positioning hole at one end, and two ends of the elastic member are received in the positioning holes of the slidable members and resist the slidable members.
